(19) United States
(12) Patent Application Publication
(10) Pub. No.: US 2005/0057508 A1
(43) Pub. Date: Mar. 17, 2005

(54) Multiple keypad mouse system

(76) Inventor: Taek Sung Kim, Syosset, NY (US)

Correspondence Address: SAMUEL S. LEE, P.O. BOX 927959, SAN DIEGO, CA, 92192-7959, US

(21) Appl. No.: 10/803,529

(22) Filed: Mar. 17, 2004

Related U.S. Application Data
(63) Continuation-in-part of application No. 10/661,946, filed on Sep. 12, 2003, now abandoned.

(51) Int. Cl. G09G 5/08; G09G 5/00

(52) U.S. Cl. 345/163

(57) ABSTRACT

A multiple keypad mouse system for providing a computer input. The system includes a plurality of keypad mouse devices, where each keypad mouse device includes first and second input elements and at least one selection element. The first input element configured to generate position signals of a cursor on the display in response to movement of the first input element. The selection element configured to enable selection of at least one item on the display. The second input element configured to generate signals providing alphanumeric input capability.

### CROSS-REFERENCE TO RELATED APPLICATIONS

This application is a continuation-in-part application of co-pending U.S. patent application Ser. No. 10/661,946, entitled “Compact Mouse Keypad”, filed Sep. 12, 2003. Benefit of priority of the filing date of Sep. 12, 2003 is hereby claimed for common material, and the disclosure of the Patent Application is hereby incorporated by reference.

### BACKGROUND

The present disclosure generally relates to computer input devices, and more specifically, to a multiple keypad mouse or mouse-like system.

A mouse is a widely-used computer input device, which has become greatly accepted among computer users. A mouse comprises essentially of a housing which can be slid by a single hand over a flat surface to generate signals in response to the relative motion of the housing over the flat surface. These signals are produced by a transducer or optical generator typically located on the bottom of the housing and are transmitted to a computer via communication means (e.g., a cable connected to a computer's input port). The signals represent orthogonal incremental motion components of the mouse in the x and y directions over the flat surface.

Generally the mouse movement is visually fed back to the user by a graphic symbol or cursor displayed on the computer screen that copies the mouse movement creating the illusion in the mind of user of directly moving it with the user's hand. The application program derives user commands according to spatial relationships between the displayed information and the cursor position on the screen when a switch is activated (usually in the form of a push-button or similar means) provided on top of the mouse for generating binary (i.e., on-off) control information.

The capability of the mouse to generate position signals plus one or more binary control signals with just one hand of the user has turned the mouse into a most useful tool for interactive computer program control. Its flexibility when used in combination with graphic programs, either graphic applications themselves or using the graphics capacity of the computer as an interactive user-machine interface, made this instrument a very popular input device, mostly for personal computer applications.

Popular applications include computer games, presentation and processing software, and Internet browsing, sometimes referred to as “web surfing”. However, in most of these applications, additional inputs in the form of alphanumeric information need to be provided to complete the task. For example, while browsing the Internet, the user may highlight and select items in the visual display by moving the mouse and clicking the button. Further, the user may also need to enter alphanumeric information to provide Internet address or to supply other pertinent information. For another example, the user may need to enter alphanumeric information, such as target information, while playing an interactive game.

Accordingly, the user needs to move the mouse with one hand to place a cursor on a desired location of the display, click the mouse button to select or highlight item(s) on the display, take the hand off the mouse, and enter the alphanumeric information on the keyboard with two hands. In normal operation of the application, this situation can arise repeatedly forcing the user to separate or decouple the selection task from the alphanumeric input task. This can create cumbersome and undesirable situation where the user's hands and arms are in a continuous back and forth movement between the mouse and the keyboard.

Prior attempts have been made to address this problem by providing a keyboard with a small transducer/actuator, such as a track ball or touch pad, coupled to the surface of the keyboard. However, these solutions still do not fully address the need to significantly reduce the decoupling of the above-mentioned tasks. Furthermore, the small size of the transducer/actuator necessitates the use of a finger rather than a hand to move the cursor, which adversely increases sensitivity and thus decreases precision movement of the cursor.

Further, a need for combined mouse and keyboard actions, such as surfing the Internet using the mouse and entering a significant amount of text using the keyboard, often arises.

Accordingly there is a need for a mouse or mouse-like device that enables entry of a plurality of functions directly from the mouse or mouse-like device.

### SUMMARY

In one aspect, a multiple keypad mouse system for providing a computer input is described. The system includes a plurality of keypad mouse devices, where each keypad mouse device includes first and second input elements and at least one selection element. The first input element configured to generate position signals of a cursor on the display in response to movement of the first input element. The selection element configured to enable selection of at least one item on the display. The second input element configured to generate signals providing alphanumeric input capability.

### BRIEF DESCRIPTION OF THE DRAWINGS

Different aspects of the disclosure will be described in reference to the accompanying drawings.

FIG. 1 illustrates a top view of a mouse device in accordance with an embodiment.

FIG. 2 illustrates a top view of a mouse device in accordance with an alternative embodiment.

FIG. 3 illustrates a top view of a mouse device in accordance with another embodiment.

FIG. 4 illustrates a top view of a mouse device in accordance with yet another embodiment.

FIG. 5 illustrates a top view of a mouse device in accordance with yet another embodiment.

FIG. 6 illustrates a side view of the mouse device illustrated in FIG. 5.

FIG. 7 illustrates the other side view of the mouse device illustrated in FIG. 5.

FIG. 8 illustrates a top view of a mouse device in accordance with a further embodiment.

FIG. 9 illustrates an implementation of a multiple keypad mouse system in which a substantial number of keys in the keyboard is represented.

FIG. 10 illustrates another implementation of a multiple keypad mouse system in which each mouse device is connected to a computer through a separate connection.

FIG. 11 illustrates yet another implementation of the multiple keypad mouse system in which each mouse device includes a display and a single row of keys.

FIG. 12 shows another implementation of the multiple keypad mouse system in which two mouse devices are configured to be connected to form a single keyboard.

### DETAILED DESCRIPTION

To meet the above-described need for a mouse device that enables entry of a plurality of functions directly from the mouse device, exemplary embodiments are described for a compact mouse device. The exemplary mouse device allows the user to enter several functions, including pointing, selecting, and inputting alphanumeric information, with only a single hand, which is normally used to control the mouse device for pointing and/or selecting function only. Furthermore, a description of configuring multiple keypad mouse devices is described below. It should be understood that references to the mouse device also includes other mouse-like devices.

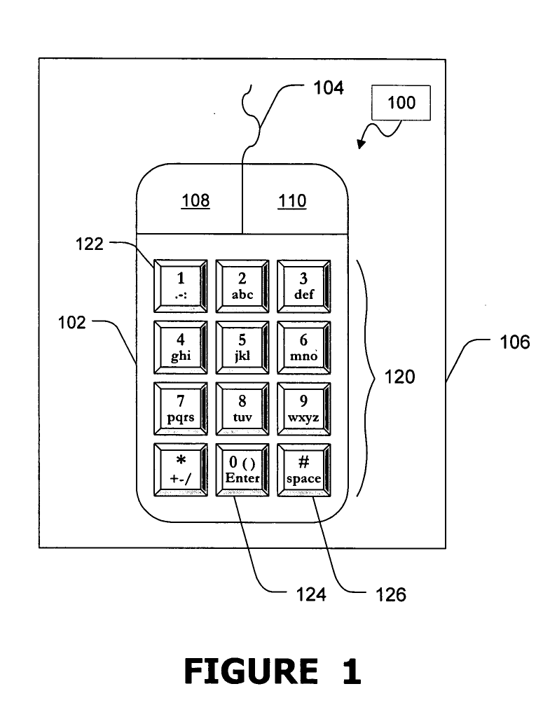

FIG. 1 illustrates a top view of a mouse device 100 in accordance with an exemplary embodiment of the present invention. The mouse device 100 includes a housing 102 that can be operated by a single hand over a flat surface 106 to generate signals in response to the relative motion of the housing 102 over the flat surface 106. These signals are produced by a transducer or optical generator (not shown) located on the bottom of the housing 102, and are transmitted to a computer via communication means, such as a cable 104 connected to a computer's input port. In some configuration, the communication means can be a communication medium enabling wireless transmission of the signals. The signals represent orthogonal incremental motion components of the mouse 102 in x and y directions over the flat surface 106.

The exemplary mouse device 100 also includes push-button switches 108, 110, which allow user commands to be communicated to the computer according to spatial relationships between the displayed information and the cursor position on the screen when the switch 108 or 110 is activated.

In accordance with the exemplary embodiment, the mouse device 100 further includes an alphanumeric keypad 120 disposed on top of the housing 102. The illustrated alphanumeric keypad 120 is similar in configuration and usage as keypads used in cellphones or other wireless communication devices. However, the layout of the keypad 120 can be modified to suit the needs for a particular usage. For example, unlike cellphone keypads, the “1” key 122 on the top left corner of the keypad 120 includes a period, a hyphen, and a colon, which are often used in entering Internet addresses. Furthermore, the keys 124, 126 include ‘Enter’ and ‘Space’ commonly used in entering phrases or sentences.

The exemplary mouse device 100 can provide all of the desired input symbols and signals for many graphical and/or interactive programs normally interfaced with a combination of conventional keyboard and mouse. Thus, means for providing inputs to the graphical and/or interactive programs is included in the exemplary mouse device 100. The desired inputs can be entered through the exemplary mouse device 100 with one hand using relatively small space, or almost no space if the mouse device 100 can be converted into a handheld remote device.

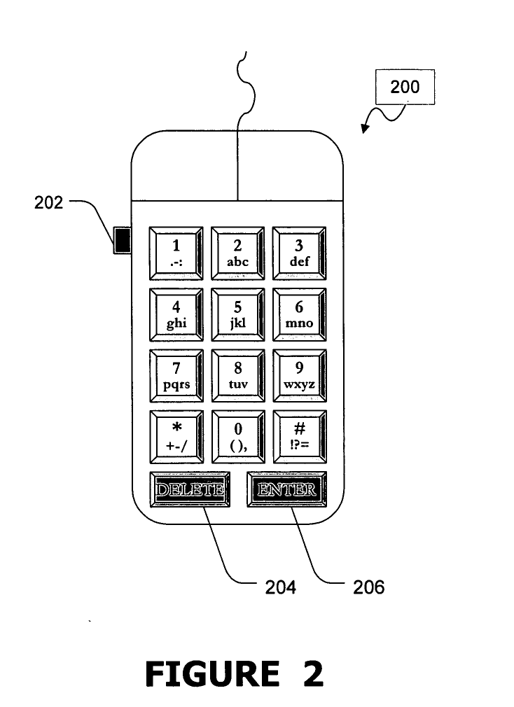

FIG. 2 illustrates a top view of a mouse device 200 in accordance with an alternative embodiment. In the alternative embodiment, the mouse device 200 further includes a ‘Space’ button 202, a ‘Delete’ button 204, and an ‘Enter’ button 206. These buttons 202, 204, 206 provide functions commonly used in entering alphanumeric inputs.

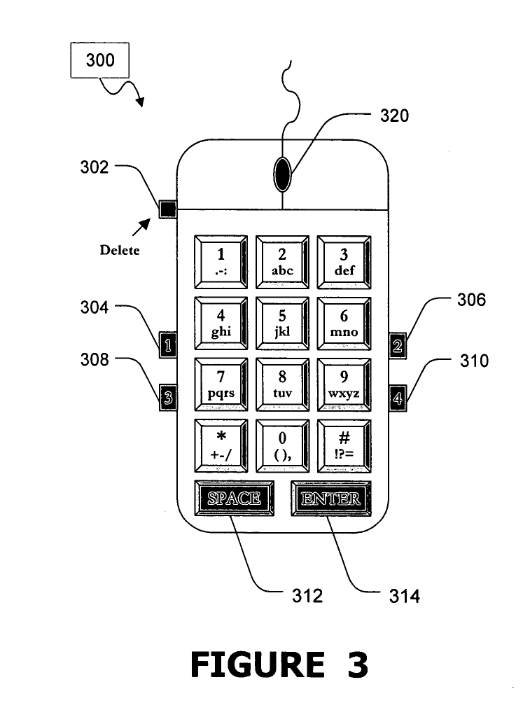

FIG. 3 illustrates a top view of a mouse device 300 in accordance with another embodiment. This embodiment shows further configurations that provide additional functions for entering alphanumeric inputs. The additional functions facilitate the efficient entry of alphanumeric inputs. Similar to the embodiment shown in FIG. 2, buttons 302, 312, 314 provide ‘Delete’, ‘Space’, and ‘Enter’ functions, respectively.

In the illustrated embodiment of FIG. 3, buttons 304, 306, 308, and 310 can be used to enable relatively quick and efficient entry of the alphanumeric inputs. For example, to enter the word ‘kin’ using the conventional method employed in most cellphones would require three presses of ‘5’ button, four presses of ‘4’ button, and three presses of ‘6’ button, for a total of ten presses. However, using the buttons 304-310, the same word ‘kin’ can be entered by simultaneously pressing buttons 308 and ‘5’, followed by buttons 310 and ‘4’, followed by 308 and ‘6’, for a total of three simultaneous button presses.

The embodiment of FIG. 3 also illustrates a scroll wheel 320, which can be used to scroll the view screen without having to click the scroll bar. The scroll wheel 320 can also be used to quickly select an alphanumeric entry. For example, the word ‘kin’ can be entered by pressing ‘5’ button and moving the scroll wheel until the entry at the cursor shows the letter ‘k’. When the entry at the cursor show the letter ‘k’, the ‘5’ button can be released to select the letter ‘k’. This process can be repeated for ‘4’ button and ‘6’ button until letters ‘i’ and ‘n’, respectively, are selected. The use of the scroll wheel 320 eliminates the need for buttons 304-310.

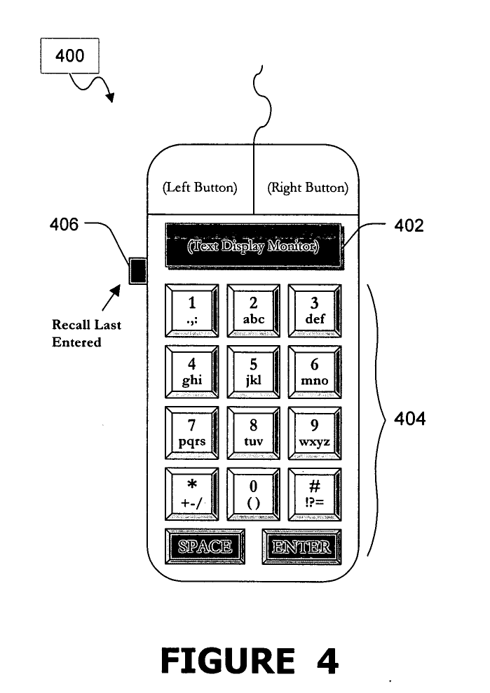

FIG. 4 illustrates a top view of a mouse device 400 in accordance with yet another embodiment. This embodiment shows further configurations that provide additional functions and features. The additional features include a text display monitor 402 that displays the input being entered on the keypad 404. The features also include a button 406 that recalls the last entry made with the keypad 404. The button 406 can be repeatedly pushed to recall further prior entries.

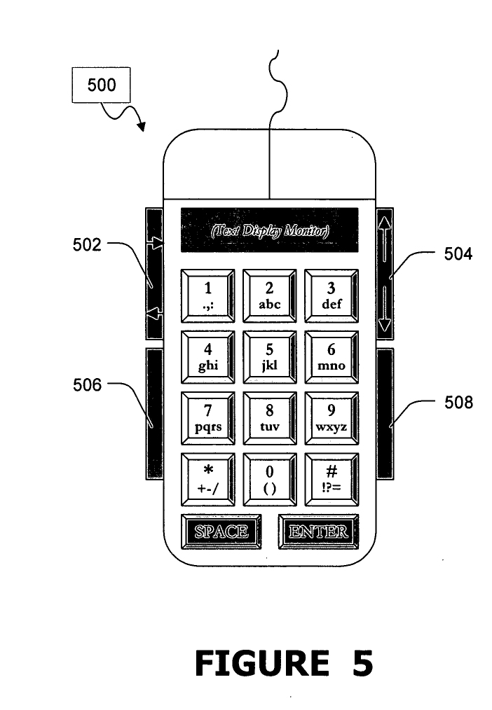

FIG. 5 illustrates a top view of a mouse device 500 in accordance with yet another embodiment. The illustrated embodiment includes additional buttons 502, 504, 506, 508, which may be used in interactive situations.

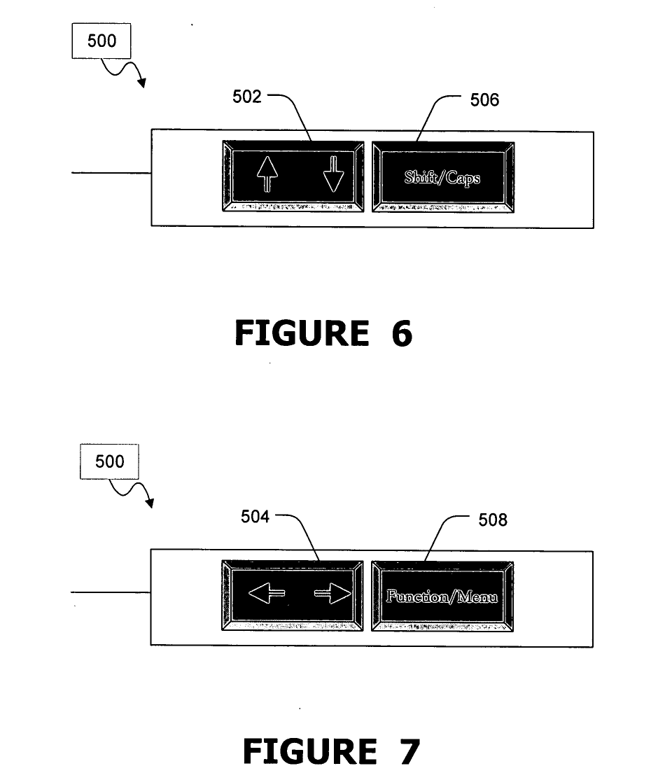

For example, FIG. 6 and FIG. 7 show left and right side views of the mouse device 500. In the side views of the mouse device 500, the buttons 502 and 504 are used to move the cursor up, down, left, and right. The buttons 506, 508 are used for ‘Cap’ and ‘Function/Menu’ input. Thus, these buttons 502, 504 can be used in an interactive game or other processing situation.

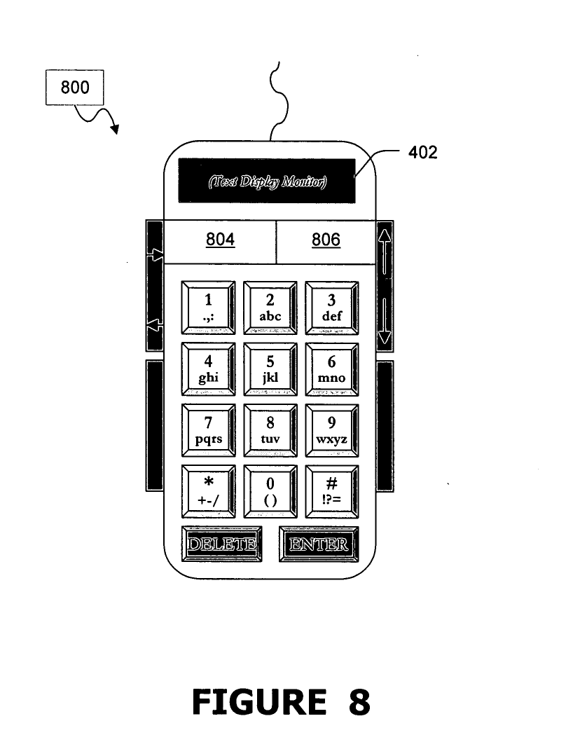

FIG. 8 illustrates a top view of a mouse device 800 in accordance with a further embodiment. This embodiment shows a variation of the embodiment shown in FIG. 4, where the text display monitor 402 is disposed above mouse buttons 804, 806 to display the text being entered without being blocked by the user's hand.

The advantages of the above-described exemplary embodiments include significant reduction in repetitive movements of hand and arm between the mouse and the keyboard and the possible reduction in the space required for work. For example, in a tight workspace, such as on an airplane, use of the compact mouse device 100, 200, 300, 400, 500, or 800 can eliminate the requirement for a keyboard.

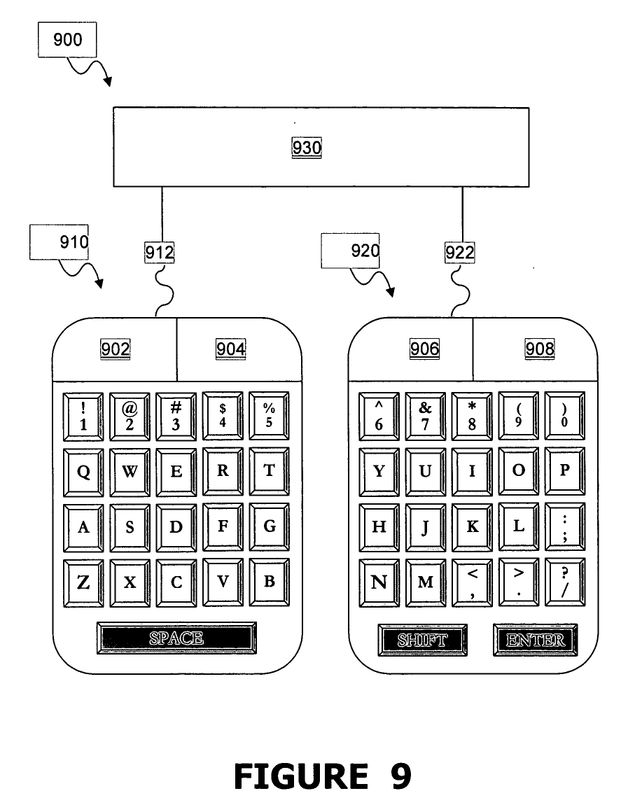

FIG. 9 illustrates an implementation of a multiple keypad mouse system 900 in which a substantial number of keys in the keyboard is represented. For example, each mouse device 910, 920 includes 20 keys for a total of 40 keys. The mouse system 900 also includes other special keys such as ‘Shift’, ‘Space’, and ‘Enter’ keys. Further, the mouse system 900 includes buttons 902, 904, 906, 908, which can act as left and right mouse buttons when the system is used as a mouse. However, when the multiple keypad mouse system 900 is used as a keyboard, the buttons 902, 904, 906, 908 can represent ‘Tab’, ‘Cap Lock’, ‘Backspace’, and/or ‘Cntl’ keys.

In the illustrated embodiment of FIG. 9, each mouse device 910, 920 in the multiple keypad mouse system 900 is separately connected to a computer 930 through a wired connection 912, 922. However, the connection 912, 922 can be made wirelessly.

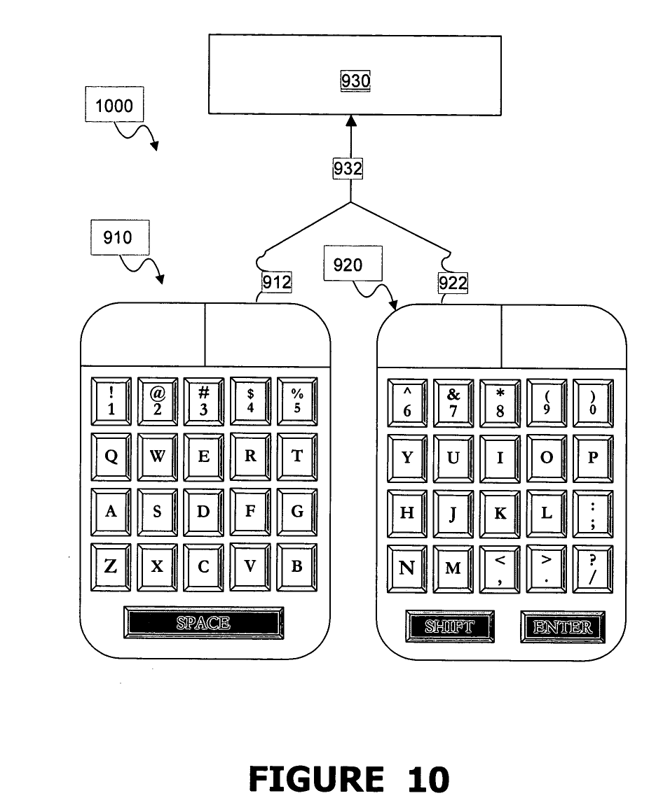

In another embodiment shown in FIG. 10, each mouse device 910, 920 of the multiple keypad system 1000 is connected to the computer 930 through a separate connection 912, 922. However, the connections 912, 922 combine into a single connection 932 before feeding into the computer 930.

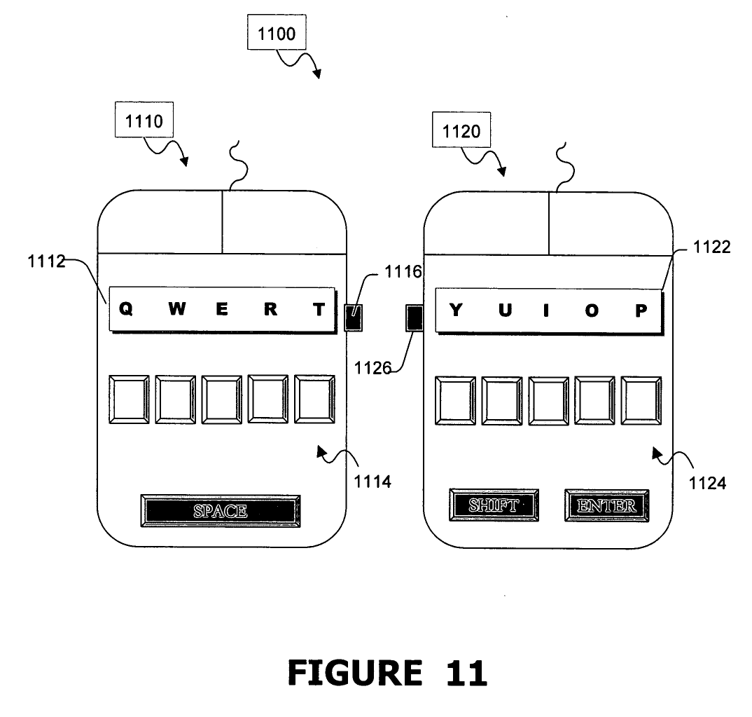

FIG. 11 illustrates yet another implementation of the multiple keypad mouse system 1100 in which each mouse device 1110, 1120 includes a display 1112, 1122 and a single row of keys 1114, 1124. Thus, each display 1112, 1122 displays the current configuration for the single row of keys. For example, in the illustrated embodiment, the mouse device 1112 displays keys ‘QWERT’, while the mouse device 1122 displays keys ‘YUIOP’. Therefore, the fives keys 1114 on the mouse device 1110 represent the displayed keys ‘QWERT’, while the five keys 1124 on the mouse device 1120 represent the displayed keys ‘YUIOP’. The configuration of the five keys can be cycled or rotated through by using the key 1116 for the mouse device 1110, and the key 1126 for the mouse device 1120.

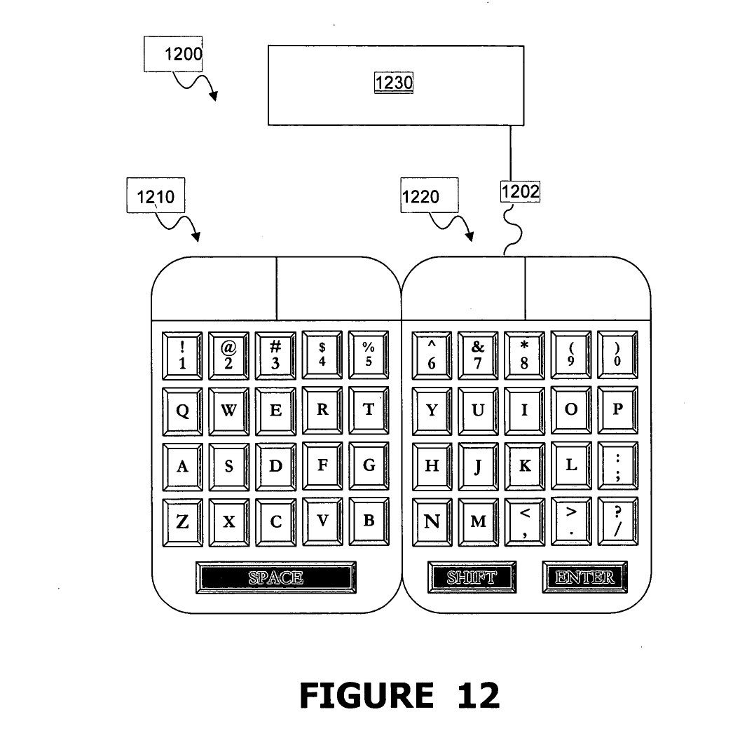

FIG. 12 shows another implementation of the multiple keypad mouse system 1200 in which two mouse devices 1210, 1220 are configured to be connected. In some embodiments, the two devices 1210, 1220 can be connected by wires or a connector. In other embodiments, the two devices 1210, 1220 can be wirelessly connected. In these embodiments, data to/from the multiple keypad mouse system 1200 is transmitted/received from/to the computer 1230 through a single connection 1202.

While specific embodiments of the invention have been illustrated and described, other embodiments and variations are possible. Although only a limited number of operational examples of the multiple keypad mouse system have been described, other similar operational uses of the mouse system are contemplated. For example, although the figures related to the multiple keypad mouse system only show two keypad mouse devices, use of more than two keypad mouse devices is contemplated.

All these are intended to be encompassed by the following claims.

1. A multiple keypad mouse system for providing a computer input, comprising:
a plurality of keypad mouse devices, each keypad mouse device including:
a first input element to generate position signals of a cursor on the display in response to movement of the first input element;
at least one selection element configured to enable selection of at least one item on the display; and
a second input element to generate signals providing alphanumeric input capability.

2. The mouse system of claim 1, wherein said each keypad mouse device includes a connection element to provide separate connection for the computer input.

3. The mouse system of claim 2, further comprising:
a connection combiner to combine the connection element from each keypad mouse device, such that said connection combiner provides a common connection for the computer input.

4. The mouse system of claim 1, wherein the second input elements from the keypad mouse devices provide a substantial portion of the keyboard keys for entering alphanumeric input.

5. The mouse system of claim 1, wherein said each keypad mouse device includes a subset of all keys necessary to provide the alphanumeric input.

6. The mouse system of claim 5, wherein said each keypad mouse device includes a display to show the current configuration of the subset of all keys.

7. The mouse system of claim 6, wherein said each keypad mouse device includes a cycle-through button for cycling through a row of different configuration of keys to represent the subset of all keys.

8. The mouse system of claim 1, wherein said each keypad mouse device includes a connecting element to connect keypad mousse device together.

9. The mouse system of claim 8, wherein said plurality of keypad mouse devices are combined using said connecting elements to form a single keyboard.

10. The mouse system of claim 9, wherein said multiple keypad mouse system includes a single connection to provide the alphanumeric input.

11. The mouse system of claim 1, wherein the second input element includes at least one alphanumeric function button.

12. The mouse system of claim 11, wherein said at least one alphanumeric function button includes a Space button.

13. The mouse system of claim 1, wherein each keypad mouse device further includes:
a display configured to display alphanumeric input provided by the second input element.

14. The mouse system of claim 13, further comprising:
a recall button operating to recall the last entered alphanumeric input on the display.
